(19) United States
(12) Patent Application Publication
(10) Pub. No.: US 2010/0114573 A1
(43) Pub. Date: May 6, 2010

(54) Method and Device for Verifying a User

(75) Inventors: Wei Huang, Shanghai (CN); Qingfeng Bao, Shanghai (CN); Ya-Xin Zhang, Shanghai (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/261,587

(22) Filed: Oct. 30, 2008

(51) Int. Cl. G10L 17/00

(52) U.S. Cl. 704/250; 704/E17.001

(57) ABSTRACT

A method and electronic device for verifying a user provides for secure speaker verification. The method includes activating a speaker verification process on the electronic device (step 305). A character string is then provided to a user of the electronic device in response to activating the speaker verification process (step 310). Next, an input utterance received from the user within a predetermined time period after providing the character string to the user is processed (step 315). The input utterance is then matched with the character string (step 320) and with stored speech data (step 325). The user is thus verified when the input utterance matches both the character string and the stored speech data.

### FIELD OF THE INVENTION

The present invention relates generally to voice recognition by electronic devices, and in particular to a method and device for verifying a user using a speaker verification process.

### BACKGROUND

Voice recognition is a powerful tool for providing input to personal electronic devices. Voice recognition technology is now a common component of mobile phones, personal digital assistants (PDAs), notebook computers, in-vehicle computers, and other electronic devices, and enables “hands-free” communications and instructions to be exchanged between a user and a device. For example, users can change volume or song selection settings on a music player, or dial a particular phone number on a mobile phone simply by enunciating verbal commands. Voice recognition is also used for example in biometric locks involving speaker verification, or voice authentication, which concern the biometric matching of voice signatures. Thus voice recognition can be used to reliably and conveniently secure access to electronic devices.

Voice recognition technology generally employs algorithms that attempt to categorize and match features of human voices with existing voice models. The models include Gaussian Mixture Model Universal Background Models (GMM-UBMs). In GMM-UBM voice recognition or speaker verification, authorized speakers are modeled with GMMs using training speech segments. A high order speaker-independent UBM is first created using a large speech corpus. Models of individual speakers are then derived from the UBM using Bayesian or Maximum a Posteriori (MAP) adaptation methods. The models are then compared with input voice feature vectors to determine whether a particular voice input, such as a spoken command or an input voice signature, matches one of the GMM-UBM models.

As with most detection systems, voice recognition systems are generally tuned so as to provide desired Receiver Operating Characteristics (ROCs). Detection/Error Tradeoff (DET) curves are a common way of measuring ROCs and evaluate two types of errors: a false rejection rate and a false acceptance rate. Concerning speaker verification, a false rejection occurs where an authorized person attempts to match his or her voice with a voice model but where the person is improperly rejected by a verification system. A false acceptance occurs where an unauthorized person, such as an imposter, is able to successfully match his or her voice, or a recorded voice, to a voice model created for another person, and thus gain improper access to a device or facility.

Many detection systems are calibrated so that the systems operate at a condition where a false acceptance rate curve crosses a false rejection rate curve. That condition is often referred to as the Equal Error Rate (EER) point and provides a balance between too many false acceptances and too many false rejections. However, efforts to avoid an unacceptable rate of false rejections, for example by tuning a system away from an EER point to tolerate a broader range of background noise, can enable imposters to defeat voice verification by using techniques such as concatenating recordings of a voice of an authorized user.

Therefore, there is a need for an improved method and device for verifying a user using voice verification.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating an electronic device in the form of a mobile telephone, according to some embodiments of the present invention;

FIG. 2 is a diagram illustrating software components that enable enrollment of a speaker on an electronic device, according to some embodiments of the present invention; and

FIG. 3 is a general flow diagram illustrating a method for verifying a user of an electronic device, according to some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a method and device for verifying a user. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

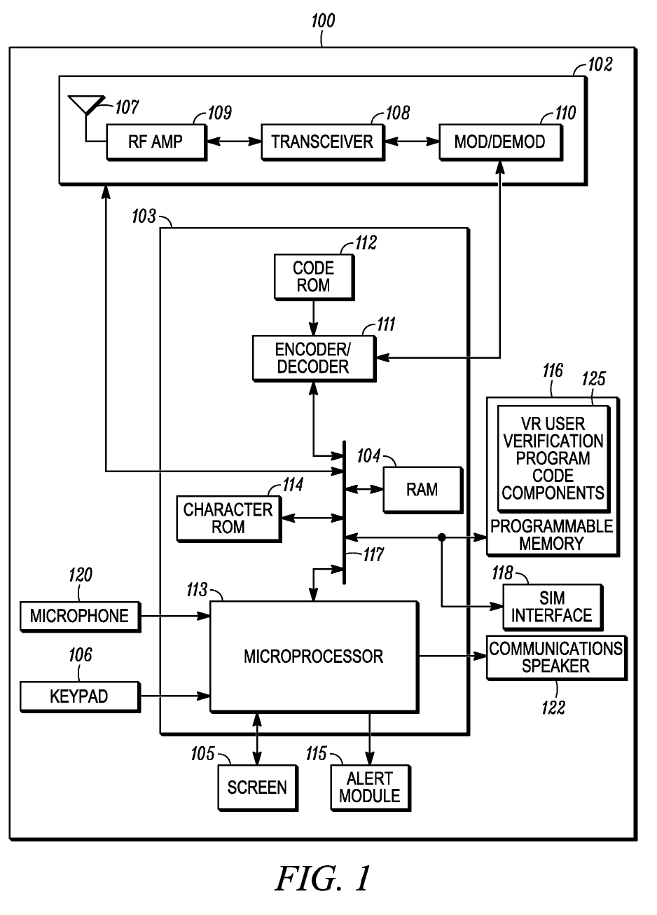

Referring to FIG. 1, a schematic diagram illustrates an electronic device in the form of a mobile telephone 100, according to some embodiments of the present invention. The mobile telephone 100 comprises a radio frequency communications unit 102 coupled to be in communication with a common data and address bus 117 of a processor 103. The mobile telephone 100 also has a keypad 106, a display screen 105, such as a touch screen, coupled to be in communication with the processor 103.

The processor 103 also includes an encoder/decoder 111 with an associated code Read Only Memory (ROM) 112 for storing data for encoding and decoding voice or other signals that may be transmitted or received by the mobile telephone 100. The processor 103 further includes a microprocessor 113 coupled, by the common data and address bus 117, to the encoder/decoder 111, a character Read Only Memory (ROM) 114, a Random Access Memory (RAM) 104, programmable memory 116 and a Subscriber Identity Module (SIM) interface 118. The programmable memory 116 and a SIM operatively coupled to the SIM interface 118 each can store, among other things, selected text messages and a Telephone Number Database (TND) comprising a number field for telephone numbers and a name field for identifiers associated with one of the numbers in the name field.

The radio frequency communications unit 102 is a combined receiver and transmitter having a common antenna 107. The communications unit 102 has a transceiver 108 coupled to the antenna 107 via a radio frequency amplifier 109. The transceiver 108 is also coupled to a combined modulator/demodulator 110 that is coupled to the encoder/decoder 111.

The microprocessor 113 has ports for coupling to the keypad 106 and to the display screen 105. The microprocessor 113 further has ports for coupling to an alert module 115 that typically contains an alert speaker, vibrator motor and associated drivers, to a microphone 120 and to a communications speaker 122. The character ROM 114 stores code for decoding or encoding data such as text messages that may be received by the communications unit 102. In some embodiments of the present invention, the character ROM 114, the programmable memory 116, or a SIM also can store operating code (OC) for the microprocessor 113 and code for performing functions associated with the mobile telephone 100. For example, the programmable memory 116 can comprise computer readable program code components 125 configured to cause execution of a voice recognition (VR) method for verifying a user of the mobile telephone 100, according to an embodiment of the present invention.

According to one aspect, the present invention includes a method for verifying a user of an electronic device such as the mobile telephone. The method includes activating a speaker verification process on the electronic device. A character string is then provided to a user of the electronic device in response to activating the speaker verification process. Next, an input utterance received from the user within a predetermined time period after providing the character string to the user is processed. The input utterance is then matched with the character string and with stored speech data. The user is thus verified when the input utterance matches both the character string and the stored speech data.

Thus, according to some embodiments of the present invention, an authorized user of an electronic device can securely access applications on the device using voice verification. Access is blocked to imposters that might attempt unauthorized access to the device using a recording of the voice of an authorized user. That is because the predetermined time period for submitting the input utterance does not provide enough time to prepare a concatenated recording, which would match the character string provided to the user, of the authorized user's voice. Improved security for electronic devices is thus enabled, without a need for extremely sensitive voice recognition software that could detect voice recordings, and without requiring users to memorize passwords, possess physical keys, or access more complex biometric locks.

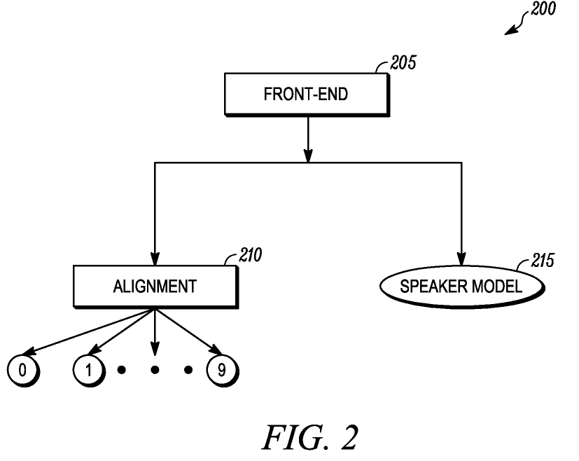

Referring to FIG. 2, a diagram illustrates software components 200 that enable enrollment of a speaker on an electronic device, according to some embodiments of the present invention. For example, the software components 200 may be included in the computer readable program code components 125 of the programmable memory 116 of the mobile telephone 100. A front end module 205 manages the enrollment process that may prompt an authorized user of the mobile telephone 100 to speak various utterances into the microphone 120. An alignment module 210 comprises a speaker dependent voice recognition (SDVR) engine that enables voice recognition of specific utterances. For example, a user may be prompted to recite each of the digits from one to nine into the microphone 120 during a training step.

Using SDVR techniques that are well known to those having ordinary skill in the art, the alignment module 210 then develops and stores speaker dependent digit models for each of the digits from one to nine. For example, Dynamic Time Warping (DTW) or Hidden Markov Models (HMM) can be used to develop the speaker dependent digit models, which enable accurate recognition of specific numerical digits in human speech even in the presence of variable background noise. Such DTW techniques are discussed, for example, in L. R. Rabiner, B. H. Juang, “Fundamentals of Speech Recognition Introduction”, New Jersey: Prentice Hall, 1993, pgs. 221 to 228. Such HMM techniques are discussed, for example, in Thomas Hain, “Hidden Model Sequence Models for Automatic Speech Recognition” University of Cambridge, 2001.

Also, a speaker model module 215 enables speaker verification (SV) of a voice of a user of the mobile telephone 100 by generating stored speech data. The stored speech data can be derived from training utterances received from the user during the enrollment process. The SV process can be independent of the SDVR engine, although the SV process can use the same input utterances used by the SDVR engine as training samples. The SV process creates a speaker model that is adapted from a universal background model (UBM) and is saved as stored speech data. For example, the SV process can be performed using Vector Quantization (VQ), HMM, or Gaussian Mixture Model (GMM) techniques. GMM techniques are discussed, for example, in D. A. Reynolds, “A Gaussian mixture modeling approach to text-independent speaker identification”, Ph.D. thesis, Georgia Inst. of Technology, September 1992. Thus the stored speech data can be any form of speech model, speech metadata or actual speech samples that enable speaker verification.

After the above described enrollment process is completed for an authorized user, the mobile telephone 100 is ready to provide secure access to features of the mobile telephone 100 using speaker verification. For example, an authorized user may touch any key on the keypad 106, or simply speak into the microphone 120 in order to activate the speaker verification process using voice activation (VOX).

Next, the mobile telephone 100 provides a character string to the user that functions as a transient password. For example, a random digit string such as “5-2-9-2-5-8-0-0” may be selected by the speaker verification process and displayed to the user on the display screen 105. Alternatively, the character string may be audibly played from the communications speaker 122 using a computer synthesized voice. Further, the character string is not limited to a digit string, but can include any alphanumeric string, including words or phrases, that can be matched to models created by the SDVR engine. For example, the character string can be an alphanumeric string selected by the speaker verification process from a group of alphanumeric strings, such as a random selection of words entered during the enrollment process (a random alphanumeric string). Because almost any character string can be used, the process can be entirely language independent.

The user is then provided with a predetermined time period during which he or she must repeat the character string as an audible utterance spoken into the microphone 120. The predetermined time period is limited, such as to only 30 seconds or less, or to only five seconds or less, to ensure that the user is presently uttering the character string. Any attempts by an imposter to concatenate recordings of an authorized user's voice to reproduce the character string are defeated because the predetermined time period does not afford adequate time to formulate the required concatenation.

The mobile telephone 100 then matches the input utterance with the character string, to ensure that the correct password was entered, and also matches the input utterance with the stored speech data, to verify that the speaker of the input utterance is an authorized user. A secure and convenient verification of a user of the mobile telephone 100 is thus realized.

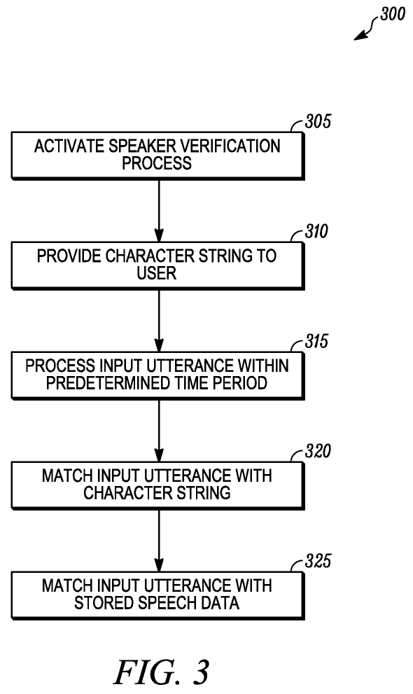

Referring to FIG. 3, a general flow diagram illustrates a method 300 for verifying a user of an electronic device, such as the mobile telephone 100, according to some embodiments of the present invention. At step 305, a speaker verification process is activated on the electronic device. For example, as described above a user may touch a key on the keypad 106 or use voice activation on the mobile telephone 100.

At step 310, a character string is provided to a user of the electronic device in response to activating the speaker verification process. For example, as described above a digit string may be displayed on the display screen 105 of the mobile telephone 100.

At step 315, an input utterance is received from the user within a predetermined time period after providing the character string to the user is processed. For example, a user of the mobile telephone 100 utters the character string into the microphone 106 by simply reading it on the display screen 105, and the utterance or models of the utterance are then stored in the programmable memory 116.

At step 320, the input utterance is matched with the character string. For example, the models created by the SDVR engine are used to match the input utterance with the digit string displayed on the display screen 105, to confirm that the correct character string was entered.

At step 325, the input utterance is matched with stored speech data. For example, the SV process on the mobile telephone 100 matches the input utterance with stored speech data in the form of a speaker model of the user such as GMM models of the user's voice. The user is thus verified when the input utterance matches both the character string and the stored speech data.

Embodiments of the present invention therefore enable an authorized user of an electronic device to securely access applications on the device using voice verification. Access is blocked to imposters that might attempt unauthorized access to the device using a recording of the voice of an authorized user. Thus improved security for electronic devices is enabled, without a need for extremely sensitive voice recognition software that could detect voice recordings, and without requiring users to memorize passwords, possess physical keys, or employ more complex and inconvenient biometric locks.

It will be appreciated that embodiments of the invention described herein may be comprised of one or more conventional processors and unique stored program instructions that control the one or more processors to implement, in conjunction with certain non-processor circuits, some, most, or all of the functions of verifying a user of an electronic device as described herein. The non-processor circuits may include, but are not limited to, a radio receiver, a radio transmitter, signal drivers, clock circuits, power source circuits, and user input devices. As such, these functions may be interpreted as steps of a method for verifying a user of an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for verifying a user of an electronic device, the method comprising:
activating a speaker verification process on the electronic device;
providing a character string to a user of the electronic device in response to activating the speaker verification process;
processing an input utterance received from the user within a predetermined time period after providing the character string to the user;
matching the input utterance with the character string; and
matching the input utterance with stored speech data;
whereby the user is verified when the input utterance matches both the character string and the stored speech data.

2. The method of claim 1, wherein the stored speech data are derived from training utterances received from the user during an enrollment process.

3. The method of claim 1, wherein the stored speech data comprise a speaker model of the user.

4. The method of claim 1, wherein the stored speech data comprise Gaussian mixture models.

5. The method of claim 1, wherein the character string is a random alphanumeric string selected by the speaker verification process.

6. The method of claim 1, wherein the character string is an alphanumeric string selected by the speaker verification process from a group of alphanumeric strings.

7. The method of claim 1, wherein the character string is provided to the user on a display screen of the electronic device.

8. The method of claim 1, wherein the input utterance is received at a microphone of the electronic device.

9. The method of claim 1, wherein the method is language independent.

10. The method of claim 1, wherein the speaker verification process is activated in response to a prompt received from the user.

11. The method of claim 1, wherein the predetermined time period is less than 30 seconds.

12. An electronic device for verifying a user, comprising:
computer readable program code components for activating a speaker verification process on the electronic device;
computer readable program code components for providing a character string to a user of the electronic device in response to activating the speaker verification process;
computer readable program code components for processing an input utterance received from the user within a predetermined time period after providing the character string to the user;
computer readable program code components for matching the input utterance with the character string; and
computer readable program code components for matching the input utterance with stored speech data;
whereby the user is verified when the input utterance matches both the character string and the stored speech data.

13. The device of claim 12, wherein the stored speech data are derived from training utterances received from the user during an enrollment process.

14. The device of claim 12, wherein the stored speech data comprise a speaker model of the user.

15. The device of claim 12, wherein the stored speech data comprise Gaussian mixture models.

16. The device of claim 12, wherein the character string is a random alphanumeric string selected by the speaker verification process.

17. The device of claim 12, wherein the character string is an alphanumeric string selected by the speaker verification process from a group of alphanumeric strings.

18. The device of claim 12, wherein the character string is provided to the user on a display screen of the electronic device.

19. The device of claim 12, wherein the predetermined time period is less than 30 seconds.

20. The device of claim 12, wherein the method is language independent.
